(19) United States
(12) Patent Application Publication
(10) Pub. No.: US 2009/0126412 A1
(43) Pub. Date: May 21, 2009

(54) Yarn fabric and manufacturing process thereof

(75) Inventors: Laurence Pollet, Lyon (FR); Jacques Porcheret, Veyssilieu (FR)

Correspondence Address: OLIFF & BERRIDGE, PLC, P.O. BOX 320850, ALEXANDRIA, VA, 22320-4850, US

(73) Assignee: PORCHER INDUSTRIES, BADINIERES (FR)

(21) Appl. No.: 12/292,522

(22) Filed: Nov. 20, 2008

Related U.S. Application Data
(60) Provisional application No. 61/071,325, filed on Apr. 22, 2008.

(30) Foreign Application Priority Data
Nov. 21, 2007 (FR) 0759198

(51) Int. Cl. D04B 23/08; D06C 15/00; C08G 75/00

(52) U.S. Cl. 66/192; 28/165; 28/172.1

(57) ABSTRACT

This yarn fabric comprises warp yarns and weft yarns, and also a slashing size present solely at the periphery of the warp yarns. This slashing size comprises at least one filler capable of modifying the properties of this fabric.

The invention relates to a yarn fabric, and also to the manufacturing process thereof.

The yarn fabric according to the invention is capable of being used in many technical fields. Mention will be made, amongst others, of electrical insulation, electronics, sound and thermal insulation, and also conveyor belts.

Typically, the constituent yarns of this fabric are more particularly, but not exclusively, made from glass. Alternatively, it is also possible to foresee using, amongst others, polyester, polyamide, or else carbon.

These yarns are formed from several filaments, the number of which is typically between two and twenty-four thousand. In the case of glass, each filament has a diameter between 3 and 15 microns, the total diameter of the yarn being between 0.01 mm and 1 cm.

The fabric according to the invention has a mass per unit area generally between 15 and 500 g/m². In the case of electrical insulation, this mass is advantageously less than 50 g/m², whereas it is in the vicinity of 200 g/m² for conveyor belts, and greater than 200 g/m² for thermal and sound insulation.

Such a fabric is formed, conventionally, by crossing various yarns, which are respectively known as warp yarns and weft yarns. In order to lubricate and to protect the warp yarns during the weaving operation, it is known to coat them by means of slashing sizing agents, after the warping operation that consists in placing these various warp yarns parallel to one another.

The main slashing sizing agents may be divided into two categories. These are firstly agents based on natural polysaccharides, especially starch, starch derivatives such as carboxymethyl starch or hydroxyethyl starch ether, cellulose derivatives, in particular carboxymethyl cellulose (CMC), galactomannans, or else protein derivatives.

It is also possible to use entirely synthetic polymers. In this case, these are for example polyvinyl alcohols (PVAs), polyacrylates, polyvinyl acetate, or else polyester.

Usually, the formulation of the slashing sizing agents uses a mixture of the substances mentioned above. After its preparation, the slashing sizing agent is deposited via impregnation onto the yarns, by means of a padder or kiss coating.

It should be noted that this slashing sizing step should not be confused with an optional coating step. Specifically, the latter concerns the treatment of the fabric itself, namely subsequent to the weaving step. Furthermore, in coating, use is made of an amount of auxiliary material that is much higher than that used in slashing sizing.

Specifically, in the slashing sizing step, the polymer deposition has a small amount, typically between 0.5 and 5% by weight. The slashing sizing polymer is usually present in an aqueous, phase. The slashing sizing bath is composed of 1 to 50% of polymer in water, this polymer being either dispersed or dissolved. At the end of the slashing sizing step described above, each warp yarn is coated with a substantially continuous sheath, that covers the whole of its periphery.

Then, the slashing sized warp yarns and the weft yarns are woven, coated solely with a coating size. It should be noted that the slashing size, which serves to protect the warp yarns from the twisting or plying stresses, is not used to coat the weft yarns, which are not subjected to such stresses during the weaving.

U.S. Pat. No. 6,593,255, WO-A-2005/077853 and U.S. Pat. No. 6,643,901 describe the incorporation of solid particles into a composition intended for coating yarns that are optionally coating sized, but free of any slashing size. In particular, the technique described in these documents should allow the penetration of solid particles between the constituent filaments of the yarns, in order to create interstitial spaces between the filaments. The first two documents aim, in particular, to obtain yarns intended to be handled by airjets, and these techniques are generally intended for the handling and positioning of weft yarns. Although this technology is described as possibly being used for incorporating particles that confer various usage properties on the fabrics, it is technically complicated and requires a specific implementation.

This being said, the invention proposes to produce a yarn fabric for which the warp yarns are slashed, which is capable of exhibiting improved properties, in different fields. The invention also aims to provide a process for manufacturing this fabric, which is substantially unchanged relative to the customary processes of the prior art, that uses a slashing step.

For this purpose, one subject of the invention is a yarn fabric, comprising warp yarns and weft yarns, and also a slashing size present solely at the periphery of the warp yarns, characterized in that this slashing size comprises at least one filler capable of modifying the properties of this fabric.

According to other features:
with the slashing size, the polymer or organic deposition on the yarn represents an amount between 0.5 and 5% by weight relative to the weight of the yarn+polymer, preferably from 0.5 to 2% by weight;
the filler is present in the slashing size in particulate form;
the filler particles are dispersed in the slashing size;
the largest dimension of the filler particles, dispersed in the slashing size, is less than 100 microns, preferably less than 50 microns; the filler particles may have dimensions between 10 nm and 100 μm, preferably between 100 nm and 50 μm;
the filler particles are present in granular form, or in the form of platelets, or in lamellar form, or in tubular form, or in the form of fibrils, or in the form of fibers, or in the form of hollow or solid spheres, or else in the form of crystals;
the filler particles are mineral, organic or metallic;
the yarns are made from an organic or inorganic artificial material, or from a natural material;
the yarns are made from glass, polyester, polyamide or carbon;
the yarns are formed from several filaments;
the filler is suitable for increasing the thermal conductivity of the fabric;
the filler comprises or is formed from boron nitride, alumina nitride, alumina, CaCO₃, copper particles or carbon nanotubes.

Another subject of the invention is a process for manufacturing the above fabric, in which a final slashing sizing bath is prepared, only the “bare” warp yarns are coated using this final slashing sizing bath, so as to form said slashing size, and the slashing sized warp yarns and the weft yarns are woven, characterized in that a primary slashing sizing bath is prepared, particles of filler are dispersed in this primary bath so as to form the final slashing sizing bath, before coating the bare warp yarns using this final slashing sizing bath. The term “bare” is understood to mean a yarn free of slashing size or of coating and that may, in particular when it is made of glass, have been treated by coating sizing. Preferably, the glass yarn is formed from several filaments and comprises a coating size.

According to other features:
the filler particles are added directly to the primary bath;
a “slurry”-type (concentrated solution) suspension is formed from said filler particles, before incorporating this suspension into the primary bath;
the primary slashing sizing bath is formed by a slashing sizing polymer itself, or is formed by a solution of this polymer in water, or else is formed by a dispersion of this polymer in water with addition of surfactants;
the proportion of fillers in the final slashing sizing bath is between 0.05 and 50% by weights preferably between 0.05 and 10%.

Another subject of the invention is a warp yarn formed from several filaments and coated with an organic polymer slashing size, said organic polymer being in a proportion of 0.5 to 5%, preferably of 0.5 to 2% by weight relative to the yarn+polymer, characterized in that filler particles are dispersed within the slashing size. The yarn may have one or more of the other features mentioned in the rest of the document. In particular, the yarn may be made from an organic or inorganic artificial material, for example from glass, polyester, polyamide or carbon. It may be coating sized. The filler may be a filler suitable for increasing the thermal conductivity of the fabric. The filler may comprise or be formed from boron nitride, alumina nitride, alumina, CaCO₃, copper particles or carbon nanotubes.

Another subject of the invention is a process for manufacturing such a yarn, comprising the passage of a coating sized yarn into a slashing sizing bath comprising the filler particles. Preferably, several yarns are made to pass simultaneously into such a bath as is described elsewhere, for example after aligning the yarns during a prior warping step. The slashing sizing bath may be prepared as described elsewhere.

When slashing sizing on the yarn is referred to, this is understood to mean the slashing size in the final state, after drying or curing.

The invention will now be described below, with reference to the appended drawings, given solely by way of non-limiting example, in which:

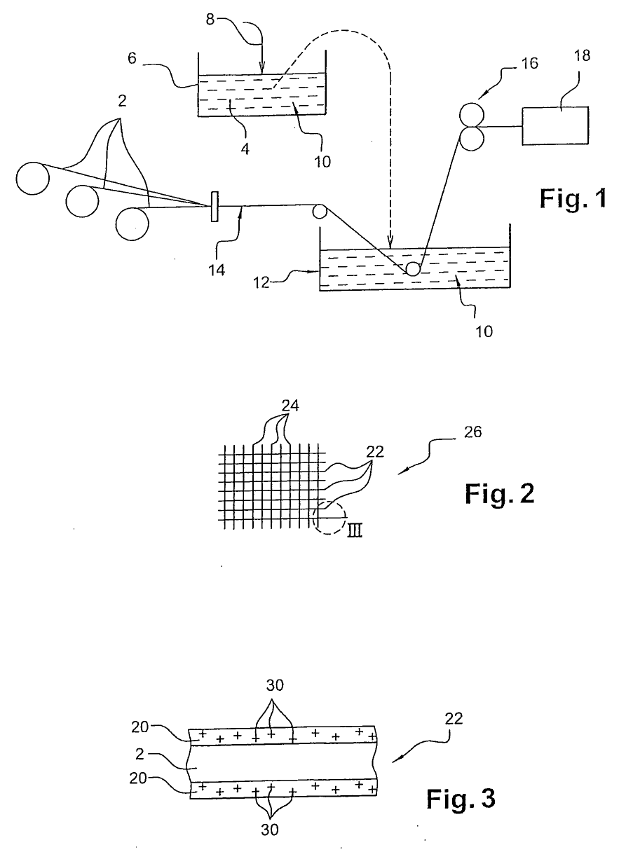

FIG. 1 is a schematic view illustrating the implementation of a process for manufacturing a yarn fabric according to the invention;

FIG. 2 is a front view, illustrating the resulting yarn fabric; and

FIG. 3 is a longitudinal cross-sectional view, illustrating a slashing sized warp yarn belonging to the fabric from FIG. 2.

The process according to the invention, illustrated with reference to FIG. 1, firstly calls for various “bare” yarns, intended to be slashing sized. After they have been slashing sized, these yarns will be woven as warp yarns, as will be described in the following.

These yarns, each of which is denoted by the reference 2, have the features described above in the preamble of the present description. They are in particular formed from several filaments, being, for example, made of glass. However, alternatively, provision may be made for them to be made from polyester, polyamide or else carbon. These bare warp yarns 2 are then subjected to a slashing sizing step.

For this purpose, a primary slashing sizing bath is firstly prepared, denoted in its entirety by the reference 4, which is produced conventionally and is stored in a container 6. This primary bath 4 is, for example, composed of the slashing sizing polymer itself, which is, in particular, PVA, and also water and surfactants. This is then a dispersion.

As a variant, it is possible to use a primary bath in the form of a polymer and water solution. As an additional variant, it is possible to use a primary slashing sizing bath which is substantially composed of polymer alone. These various possibilities are well known to a person skilled in the art, so much so that they will not be described more specifically in the present text.

The operating conditions of the primary bath are also of the type that is customary in the prior art. Thus, this bath has, for example, a temperature in the vicinity of ambient temperature, and also a viscosity between, for example, 10 and 500 mPa·s.

It is then a question of adding, to the primary bath 4, at least one filler capable of modifying the properties of the final fabric. In a non-limiting manner, in what follows various types of filler capable of being used in the context of the present invention will be listed.

It is firstly possible to use fillers capable of improving the mechanical properties of the fabric. These may be glass fibers, carbon fibers, or natural, synthetic or cellulose fibers. The various fibers above are of the “short” type, namely they have dimensions of less than 100 microns. It is also possible to use mineral fillers, in particular such as CaCO₃, talc, silica, microspheres or else nanofillers. Finally it is possible to use an organic filler, such as block copolymers.

Within the context of the invention, it is also possible to use fillers capable of improving the appearance of the fabric. These are, in particular, pigments or dyes, optionally of interference, photochromic or thermochromic type, and also rare-earth particles suitable for providing an authentication function.

It is also possible to use fillers suitable for giving the fabric an improved heat resistance. These may be glass fibers, carbon fibers, or natural or synthetic fibers. It is also possible to provide antioxidants, nanofillers, heat stabilizers such as metallic barium-zinc salts, or else epoxidized soybean oil.

Certain fillers, which may be used by the invention, are of the type to improve the lightfastness of the fabric. These may be, for example ultraviolet absorbers, HALSs (hindered amine light stabilizers), nanofillers, titanium dioxide, benzophenones, or else benzotriazols.

It is also possible to use fillers capable of improving the fire resistance of the fabric. These may be, for example, halogenated compounds, zinc stannates, phosphorus compounds, intumescent particles, nanofillers, alumina trihydrates or else zinc borates.

It is also possible to use fillers that can improve the electrical conductivity properties of the fabric. These may be carbon fibers, glass beads, carbon nanotubes, conductive polymers, such as polyanilines, or else metalized particles.

The thermal conductivity properties of the fabric may also be improved, by using specific fillers according to the invention. These are, for example, boron nitride, alumina nitride, alumina, CaCO₃, or else copper particles, or carbon nanotubes.

According to the invention, it is also possible to use fillers suitable for giving the fabric improved coupling properties. These are, for example, organic fillers, such as organosilanes, organozircoaluminates, isocyanates, melamines, polyamideimide, or else functionalized polymers.

The invention may also call for fillers as blowing agents. These may then be, for example, sodium bicarbonate, hydrocarbons, fluorocarbons, or else azodicarbonamides.

Silicone fillers may be also be used, as a processing aid, due to their lubricating properties.

It is also possible to use, as antibacterial, biocidal or antifungal agents, other specific fillers. These may then be, for example, quaternary ammonium, chitosan, silver salts, or else nanosilver.

It is also possible to use fillers suitable for giving the fabric improved acoustic properties. These may be, for example, glass microspheres or else silica aerogels.

Other fillers may be used, with a view to improving the recyclability of the fabric. These may be, for example, photocatalytic fillers, of the TiO₂ type.

Finally, certain fillers are capable of improving the thermal insulation properties of the fabric. These are, in particular, phase-change molecules, such as encapsulated waxes.

Advantageously, use is made of fillers, such as, for example, those listed above, in particulate form. In the meaning of the invention, these particles may be granules, platelets, lamellae, tubes, fibrils, fibers, hollow or solid spheres, or else crystals.

Advantageously, the largest dimension of these filler particles is less than 100 microns, preferably less than 50 microns.

It is possible to envisage two possibilities, with a view to the dispersion of the fillers in the primary bath 4. Thus, it is firstly possible to directly incorporate these fillers into this primary bath, in powder form. After this incorporation, stirring is carried out in order to disperse these fillers in the bath. This first embodiment is not however illustrated in the figures.

As a variant, shown in FIG. 1, a “slurry”, namely a thick and concentrated suspension of solids in a liquid, is firstly prepared. For this purpose, the fillers are pre-dispersed in an aqueous or polymer medium, optionally in the presence of dispersants.

The concentration of fillers in this “slurry” is much higher than that which these fillers possess, once dispersed in the slashing size. Once this “slurry” is stabilized, it is introduced, with stirring, into the primary bath 4, according to the arrow 8 in FIG. 1. A final slashing sizing bath is then obtained, indicated by the reference 10, which comprises the primary bath 4 and also the slurry 8.

The percentage of fillers present in the “slurry” 8 is between 10 and 80% by weight. The proportion of “slurry” 8 present in the final slashing sizing bath 10 is between 0.5 and 62.5% by weight. Finally, the proportion of fillers in this final bath 10 is between 0.05 and 50% by weight.

The final slashing sizing bath 10 is then transferred into a tank 12. The various warp yarns 2, formed in accordance with a sheet 14, are then coated by this slashing sizing bath 10, in a conventional manner. Downstream of this tank, the yarn sheet passes, also in a manner known per se, through two rolls 16, that form a “padder”. Finally, this sheet is dried in the usual manner, for example in an oven 18, or else on hot rolls.

At the end of the above operations, each “bare” warp yarn 2 is coated with a slashing size sheath 20. As is known, this sheath, or slashing size, which has a very small thickness, makes it possible to attach the constituent filaments of each yarn to one another.

The reference 22 is given to each slashing sized warp yarn. The various slashing sized warp yarns 22 are then subjected to a weaving operation, in a conventional manner, with the weft yarns 24. This makes it possible to form a fabric according to the invention, denoted in its entirety by the reference 26.

FIG. 3 represents, in longitudinal cross section, a portion of slashing sized warp yarn 22 comprising the bare yarn 2, around which the slashing size 20 extends. The latter is represented on a larger scale than in reality, for reasons of clarity. As seen above, this slashing size contains fillers, which are represented schematically and indicated by the reference 30.

These various fillers 30 are not soluble, namely they remain present in the slashing size 20, after the operation that consists in dispersing them in this slashing size. However, given that they are dispersed, they are distributed homogeneously in this slashing size. In other words, these fillers are in the form of separate particles, that do not significantly form agglomerates therein. Consequently, the largest dimension of the fillers, within the final slashing size, is substantially equal to their largest initial dimension, defined above, namely less than 100, in particular 50, microns.

The invention makes it possible to achieve the aforementioned objectives.

As is known per se, the yarns used to form a weaving, in particular made from glass, have good tensile strength, but are extremely brittle when they are plied. Under these conditions, in order to achieve this weaving, it is necessary to form a slashing size around the warp yarns. In the prior art, this slashing size is only used for weaving the fibers and, in most cases, it is removed immediately after the weaving operation.

Furthermore, it is well known that the fillers, that the invention proposes to incorporate, are by nature of random shape, and are usually crystalline, i.e. they are consequently abrasive. Under these conditions, a person skilled in the art has no incentive to introduce such fillers into the slashing size, insofar as he considers that this filler will contribute to attacking the yarn, which is antinomic with the presence of the slashing size, which has, on the contrary, the role of protecting this yarn.

The present invention makes it possible to overcome this prejudice of a person skilled in the art. This is because, according to the invention, the particulate fillers are dispersed in the slashing size, i.e. they are substantially separate and, consequently, have a very small size. Under these conditions, they are not of the nature to attack the yarn.

Furthermore, the fact of introducing fillers into the slashing size has specific advantages.

This is because it makes it possible to provide at least one additional property to the fabric, without passing through an additional machine.

The property in question is provided in a unidirectional manner, since the particles are distributed only along the warp yarns. By comparison, a coating of the fabric requires not only the warp yarns, but also the weft yarns, to be covered.

Furthermore, the invention is not accompanied by any significant modification of the porosity of the fabric, nor of its opening ratio.

Finally, the invention is advantageous in terms of the manufacturing process, since the additional property may be provided without increasing the overall cost of the manufacturing process. Specifically, the addition of fillers is integrated into the operation that consists in adding the slashing size. Furthermore, the latter only represents a small deposition level and only concerns the warp yarns.

Various exemplary embodiments will be presented below, solely by way of non-limiting implementation methods.

### EXAMPLE 1

Around 6 kg of polyvinyl alcohol, such as ELVANOL T66 from Dupont, were slowly added to 100 kg of water at ambient temperature. This was then stirred for 15 min.

As soon as the powder was correctly dispersed, the mixture was heated to 95° C. in order to dissolve the polyvinyl alcohol. The bath was kept stirring constantly. At the end of one hour, the solution became clear and colorless.

Next, 1 kg of alumina, such as BRH 26 from Durmax, was incorporated in the form of a shower. Vigorous stirring was maintained for 15 min. Next, the resulting dispersion was decanted into the slashing sizing tank. The glass yarns were then treated by impregnation, and then they were dried in an oven at a temperature in the vicinity of 120° C. These slashing sized glass yarns were then woven, as warp yarns, with non-slashing sized weft yarns.

The fabric obtained had an additional property of thermal conductivity, without substantial modification of its initial properties. In order to illustrate the retention of these properties, mechanical strength measurements were carried out, on the one hand, on a yarn produced conventionally and, on the other hand, on the same yarn treated in accordance with the invention.

For this purpose, EC 5.5. tex 622 glass yarns from AGY were used, that were treated according to the above procedure. A mechanical strength test was then carried out on this yarn treated in accordance with the invention, according to the NF B 38110 standard. The breaking strength was 6.1+/−0.5 N whereas, in comparison, the breaking strength of this same yarn, treated conventionally, was 5.2+/−0.9 N.

The use of this first example therefore shows that the presence of fillers in the slashing size does not contribute to attacking the yarn, insofar as the latter does not undergo substantial variations in its mechanical strength.

### EXAMPLE 2

A Solution of polyvinyl alcohol in water was prepared in the same way as described at the start of Example 1. Then, a pre-dispersion of carbon black, of the black A type from Sicolor, was added. Vigorous stirring was maintained for 15 min.

The dispersion obtained was then decanted into the slashing sizing tank. The glass yarns were treated by impregnation, then dried and woven as in the embodiment from Example 1. A colored, in this case black, fabric was obtained without additional treatment via impregnation or coating. Furthermore, the provision of this color, in accordance with the invention, was not accompanied by significant change in the porosity of the fabric.

For this purpose, a fabric 3228, treated according to the invention, was tested using the ISO 9237 standard. The measure obtained was 267+/−8 l/dm²/min. In comparison, the same fabric slashing sized conventionally, but not colored in accordance with the invention, had a measurement of 260+/−10 l/dm²/min. The two fabrics, respectively conventional and treated according to the invention, therefore had similar porosities.

### EXAMPLE 3

100 kg of an aqueous acrylic dispersion, such as ACRONET 280 from Hispano Quimica, was stirred. It was stirred for 15 min.

Next, around 6 kg of a flame-retardant aqueous dispersion, based on phosphorus, of the FLACAVON H14/112 type from Schill and Seilacher was incorporated. Vigorous stirring was maintained for 15 min, then the resulting dispersion was decanted into the slashing sizing tank. The glass yarns were treated by impregnation, they were dried and they were woven, according to the same procedure as described in Examples 1 and 2.

A fire-retardant fabric was then obtained, without additional coating treatment. In other words, Example 3 illustrates an economic advantage of the invention, in the sense that the latter makes it possible to make a saving of one processing step.

1. Yarn fabric, comprising warp yarns and weft yarns, and also a slashing size present solely at the periphery of the warp yarns, wherein this slashing size comprises at least one filler capable of modifying the properties of this fabric.

2. Fabric according to claim 1, wherein the slashing size comprises a polymer that represents from 0.5 to 5% of the warp yarn+polymer weight.

3. Fabric according to claim 1, wherein the slashing size comprises a polymer that represents from 0.5 to 2% of the warp yarn+polymer weight.

4. Fabric according to claim 1, wherein the filler (30) is present in the slashing size in particulate form.

5. Fabric according to claim 4, wherein the particles of filler are dispersed in the slashing size.

6. Fabric according to claim 5, wherein the largest dimension of the filler particles, dispersed in the slashing size, is less than 100 microns.

7. Fabric according to claim 4, wherein the filler particles are present in granular form, or in the form of platelets, or in lamellar form, or in tubular form, or in the form of fibrils, or in the form of fibers, or in the form of hollow or solid spheres, or else in the form of crystals.

8. Fabric according to claim 4, wherein the filler particles are mineral, organic or metallic.

9. Fabric according to claim 1, wherein the yarns are made from glass, polyester, polyamide or carbon.

10. Fabric according to claim 1, wherein the yarns are formed from several filaments.

11. Fabric according to claim 1, wherein the filler is suitable for increasing the thermal conductivity of the fabric.

12. Fabric according to claim 11, wherein the filler comprises or is formed from boron nitride, alumina nitride, alumina, CaCO₃, copper particles or carbon nanotubes.

13. Process for manufacturing the yarn fabric according to claim 1, in which a final slashing sizing bath is prepared, only the bare warp yarns are coated using this final slashing sizing bath, so as to form said slashing size, and the slashing sized warp yarns and the weft yarns are woven, wherein a primary slashing sizing bath is prepared, particles of filler are dispersed in this primary bath so as to form the final slashing sizing bath, before coating the bare warp yarns using this final slashing sizing bath.

14. Manufacturing process according to claim 13, wherein the filler particles are added directly to the primary bath.

15. Manufacturing process according to claim 13, wherein a “slurry”-type suspension is formed from said filler particles, before incorporating this suspension into the primary bath.

16. Manufacturing process according to claim 13, wherein the proportion of fillers in the final slashing sizing bath is between 0.05 and 50% by weight.

17. Manufacturing process according to claim 13, wherein the simultaneous slashing sizing of several warp yarns that are parallel to one another is carried out, after a warping operation.

18. Manufacturing process according claim 13, wherein the slashing size comprises a polymer representing from 0.5 to 5% of the warp yarn+polymer weight.

19. Warp yarn formed from several filaments and coated with an organic polymer slashing size, said organic polymer being in a proportion of 0.5 to 2% by weight relative to the yarn+polymer, wherein filler particles are dispersed within the slashing size.
